(19) United States
(12) Patent Application Publication
(10) Pub. No.: US 2009/0219953 A1
(43) Pub. Date: Sep. 3, 2009

(54) METHOD AND APPARATUS FOR ALLOWING NON-IP BASED NETWORKS TO INTERACT WITH IPTV-BASED SYSTEMS

(75) Inventors: David S. Benco, Winfield, IL (US); Mark A. Ristich, Naperville, IL (US)

Correspondence Address: FAY SHARPE/LUCENT, 1228 Euclid Avenue, 5th Floor, The Halle Building, Cleveland, OH, 44115-1843, US

(73) Assignee: LUCENT TECHNOLOGIES INC., Murray Hill, NJ (US)

(21) Appl. No.: 12/039,126

(22) Filed: Feb. 28, 2008

(51) Int. Cl. H04H 20/28

(52) U.S. Cl. 370/487

(57) ABSTRACT

A method of allowing a non-IP-based network to interact with an IPTV-based network is provided. The method comprises: receiving an indication at an IPTV Mediation Application Server (IPTV Mediation AS) that a subscriber to IPTV service is watching television, wherein the television is connected to an IPTV set-top box (IPTV STB) in a home viewing network; receiving a call from a caller directed to a circuit-switched communication device of the subscriber; suspending normal call processing and giving control of the call to the IPTV Mediation AS; interacting with the home viewing network and sending instructions to the IPTV STB regarding a pop-up message to be played on the television; receiving instructions for handling the call at the IPTV Mediation AS; and sending the instructions for handling the call to a service switching point.

### BACKGROUND OF THE INVENTION

This invention relates to a method and apparatus allowing non-IP based telecommunications networks to interact with IPTV-based systems to provide substantially equivalent capability as would be provided by IMS telecommunications networks. While the invention is particularly directed to the art of telecommunications, and will be thus described with specific reference thereto, it will be appreciated that the invention may have usefulness in other fields and applications.

By way of background, IPTV (Internet Protocol Television) is a system in which digital television service is delivered by using Internet Protocol over a network infrastructure, which may include delivery by a broadband connection. A general definition of IPTV is television content that, instead of being delivered through traditional broadcast and cable formats, is received by the viewer through the technologies used for computer networks.

For residential users, IPTV is often provided in conjunction with Video on Demand and may be bundled with Internet services such as Web access and VoIP. IPTV is typically supplied by a service provider using a closed network infrastructure. This closed network approach is in competition with the delivery of TV content over the public Internet, called Internet Television. In businesses, IPTV may be used to deliver television content over corporate LANs.

IPTV covers both live TV (multicasting) as well as stored video (Video on Demand VOD). The playback of IPTV requires either a personal computer or a set-top box connected to a TV. Video content is typically compressed using either a MPEG-2 or a MPEG-4 codec and then sent in an MPEG transport stream delivered via IP Multicast in case of live TV or via IP Unicast in case of Video on Demand. IP Multicast is a method in which information can be sent to multiple computers at the same time. The newly released (MPEG-4) H.264 codec is increasingly used to replace the older MPEG-2 codec.

Another advantage of an IP-based network is the opportunity for integration and convergence. The term “converged services” implies interaction of existing services in a seamless manner to create new value added services. One good example is On-Screen Caller ID, that is, getting Caller ID on your TV and the ability to handle it (send it to voice mail, etc). IP-based services help to provide consumers anytime-anywhere access to content over their televisions, PCs and cell phones, and to integrate services and content to tie them together. IPTV Call Handling features (such as Caller ID display, reject the call, send to voice mail, etc.) are available to IMS (IP Multimedia Subsystem) subscribers. This is relatively straightforward since IMS subscribers and IPTV reside in the same technology domain (i.e., both are IP-based services). The problem at hand is to offer equivalent IPTV-based services to legacy network-based subscribers. This is an important problem since the vast majority of telecommunications subscribers have not yet migrated to IMS or other VoIP solutions.

The current art for IPTV-based ancillary services is limited to IP-based telecommunications subscribers. This does work well for IMS subscribers, but is not useful to the hundreds of millions of circuit-switched subscribers worldwide. Examples include PSTN subscribers and most CDMA, and UMTS/GSM mobile subscribers. These subscribers require a different solution for IPTV call handling; migrating to IMS in the near term is simply not practical.

The present invention contemplates a new and improved method that resolves the above-referenced difficulties and others.

### SUMMARY OF THE INVENTION

In one aspect of the invention a method of allowing a non-IP-based network to interact with an IPTV-based network is provided. The method comprises: receiving an indication at an IPTV Mediation Application Server (IPTV Mediation AS) that a subscriber to IPTV service is watching television, wherein the television is connected to an IPTV set-top box (IPTV STB) in a home viewing network; receiving a call from a caller directed to a circuit-switched communication device of the subscriber; suspending normal call processing and giving control of the call to the IPTV Mediation AS; interacting with the home viewing network and sending instructions to the IPTV STB regarding a pop-up message to be played on the television; receiving instructions for handling the call at the IPTV Mediation AS; and sending the instructions for handling the call to a service switching point.

In another aspect of the invention an apparatus for allowing a non-IP-based network to interact with an IPTV-based network is provided. The apparatus comprises: first receiving means for receiving an indication that a subscriber to IPTV service is watching television, wherein the television is connected to an IPTV set-top box (IPTV STB) in a home viewing network; second receiving means for receiving a call from a caller directed to a circuit-switched communication device of the subscriber; suspending means for suspending normal call processing and taking control of the call; interacting means for interacting with the home viewing network and sending instructions to the IPTV STB regarding a pop-up message to be played on the television; third receiving means for receiving instructions for handling the call; and sending means for sending the instructions for handling the call to a service switching point.

In yet another aspect of the invention a system for allowing a non-IP-based network to interact with an IPTV-based network is provided. The system comprises: an IPTV Mediation AS connected to the service switching point, wherein the IPTV Mediation AS is operative to: receive an indication that a subscriber to IPTV service is watching television, wherein the television is connected to an IPTV set-top box (IPTV STB) in a home viewing network; receive a call from a caller directed to a circuit-switched communication device of the subscriber; suspend normal call processing and give control of the call to the IPTV Mediation AS; interact with the home viewing network and send instructions to the IPTV STB regarding a pop-up message to be played on the television; receive instructions for handling the call at the IPTV Mediation AS; and send the instructions for handling the call to a service switching point. The system further comprises a subscriber database storing data for a plurality of circuit-switched telephone subscribers having IPTV service in communication with the IPTV Mediation AS.

Further scope of the applicability of the present invention will become apparent from the detailed description provided below. It should be understood, however, that the detailed description and specific examples, while indicating preferred embodiments of the invention, are given by way of illustration only, since various changes and modifications within the spirit and scope of the invention will become apparent to those skilled in the art.

### DESCRIPTION OF THE DRAWINGS

The present invention exists in the construction, arrangement, and combination of the various parts of the device, and steps of the method, whereby the objects contemplated are attained as hereinafter more fully set forth, specifically pointed out in the claims, and illustrated in the accompanying drawings in which:

FIG. 1 is a block diagram of a system into which the exemplary embodiments may be incorporated;

FIG. 2 is a memory layout of data stored in the database for legacy and circuit-switched telephone subscribers;

FIG. 3 is a flow chart illustrating a method of IPTV call handling for legacy and circuit-switched telephone subscribers in accordance with aspects of the present invention; and

FIG. 4 is a call flow for incoming Caller ID notification on IPTV of non-IMS incoming call

### DETAILED DESCRIPTION

Portions of the present invention and corresponding detailed description are presented in terms of software, or algorithms and symbolic representations of operations on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be kept in mind, however, that all of these and similar terms are to be associated with the appropriate physical quantities and are merely convenient labels applied to these quantities. Unless specifically stated otherwise, or as is apparent from the discussion, terms such as “processing” or “computing” or “calculating” or “determining” or “displaying” or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the invention are typically encoded on some form of program storage medium or implemented over some type of transmission medium. The program storage medium may be magnetic (e.g., a floppy disk or a hard drive) or optical (e.g., a compact disk read only memory, or “CD ROM”), and may be read only or random access. Similarly, the transmission medium may be twisted wire pairs, coaxial cable, optical fiber, or some other suitable transmission medium known to the art. The invention is not limited by these aspects of any given implementation.

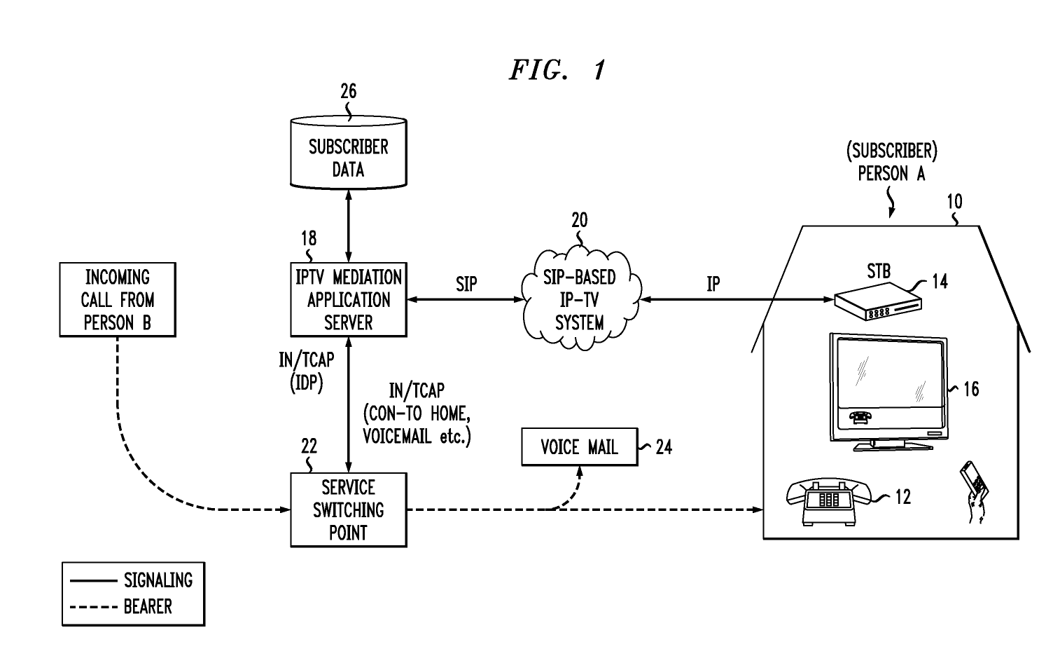

Referring now to the drawings wherein the showings are for purposes of illustrating the exemplary embodiments only and not for purposes of limiting the claimed subject matter, FIG. 1 provides a view of a system into which the presently described embodiments may be incorporated. As shown generally, FIG. 1 includes a home viewing network 10 for Person A (in this case the subscriber). A home viewing network is a network that has one or more communication devices 12, one or more Set-Top Boxes (STBs) 14, and one or more viewing devices 16. An IPTV Mediation AS 18 receives IPTV streams and broadcasts within the home network 10 the IPTV streams associated with television broadcasts, pay-per view broadcasts, Internet video broadcasts, and the like. The maximum number of available IPTV streams is bounded by the IPTV Mediation AS 18 capabilities or the maximum bandwidth capabilities of the home viewing network 10.

The components of the home viewing network 10 may be arranged in any desired fashion. The IPTV Mediation AS 18 interfaces with the home viewing network 10 via a SIP-based IPTV system 20. SIP (Session Initiation Protocol) is an application-layer control (signaling) protocol for creating, modifying, and terminating sessions with one or more participants. It can be used to create two-party, multiparty, or multicast sessions that include Internet telephone calls, multimedia distribution, and multimedia conferences. SIP is designed to be independent of the underlying transport layer; it can run on TCP, UDP, or SCTP. The latest version of the specification is RFC 3261 from the IETF SIP Working Group. It is widely used as a signaling protocol for Voice over IP, along wth H.323 and others.

The home viewing network 10 may be wired, wireless, or a combination of wired and wireless. It is also noted that although the term “home” is used in connection with the phrase “home viewing network” that the network is not limited to a residential home or dwelling. That is, any local area network within a defined area viewing area accessible to a single account with an IPTV provider may be viewed as a home viewing network. With regard to the invention disclosed herein, the communication device 12 is generally a wire line or wireless phone connected to the legacy or circuit-switched network with terminating IN triggers set.

The viewing device 16 is a television or a monitor that permits video or television broadcasts to be viewed thereon. In some cases, the STB (Digital Versatile Recorder (DVR), etc.) 14 may be viewed as a remote viewing device, if that STB includes the processing instructions associated with directly interfacing with the IPTV system 20. Moreover, each remote viewing device directly interfaces with a viewing device that is capable of presenting the IPTV streams of the home viewing network. Also, in some cases where the remote viewing device is not a STB, a remote viewing device may be directly interfaced with that STB.

An SSP (Service Switching Point) 22 is in communication with the IPTV Mediation AS 18 and with a voice mail system 24. The SSP 22 functions as the telephone exchange that responds when a telephone caller such as Person B dials the subscriber's number. In this example, the SSP 22 is the switch associated with the “called” party. The SSP 22 sends a query to a Service Control Point (SCP) so that the call can be handled. In this example, the IPTV Mediation AS 18 serves as the SCP.

The IPTV Mediation AS 18 generally includes a CPU (not shown) such as a microprocessor or a secure server and is in communication with a subscriber database 26 for storing pertinent information as to whether the called party has the “call presentation and call handling on IPTV feature,” among other things. The database 26 may be a Home Subscriber Server (HSS), or a special dedicated database for IPTV service. An HSS is a master user database that supports the IMS network entities that actually handles calls. It contains the subscription-related information (user profiles), performs authentication and authorization of the user, and can provide information about the user's physical location.

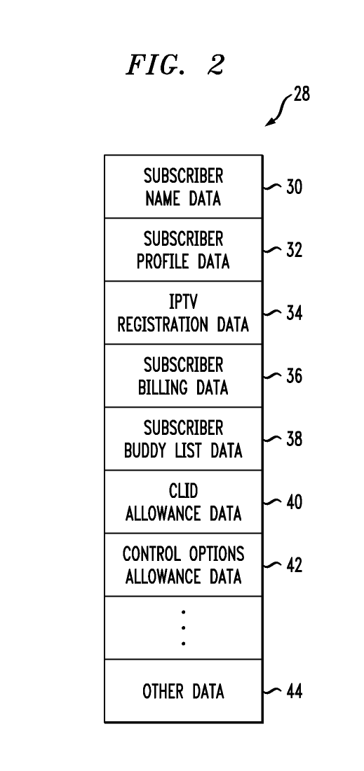

The subscriber database 26 generally includes any number of data sub-blocks for each circuit-switched telephone subscriber also having IPTV service, as shown in FIG. 2. They are shown as a super block 28, not all of whose fields are filled for a particular subscriber. The super block 28, as known in the art, can be accessed from the identity of any one of several fields within it. The super block 28 includes any number of data sub-blocks, including a first sub-block 30 that contains subscriber name data, a second sub-block 32 that contains subscriber profile data, a third sub-block 34 that contains IPTV registration data, a fourth sub-block 36 that contains subscriber billing account data, a fifth sub-block 38 that contains “buddy list” data, a six sub-block 40 that contains CLID allowance data, and a seventh sub-block 42 that contains control options allowance data. Of course, any number of additional sub-blocks 44 may be provided in the super block 28 for storing other pertinent data.

The IPTV Mediation AS 18 bridges the gap between the IN/TCAP protocols used in the legacy circuit-based networks and the IP-based (e.g., SIP, etc.) domain in which IPTV resides. In this way, the existing set top box (STB) APIs can be used without change. From the perspective of the SIP interface to the IPTV network 20, the IPTV Mediation AS 18 is indistinguishable from an IMS network element or other SIP-based network element. All of the circuit-specific interactions are mediated by the IPTV Mediation AS 18. From the subscriber's perspective, the Caller ID presentation simply appears on his/her IPTV with subsequent call handling controlled by the subscriber's TV remote control.

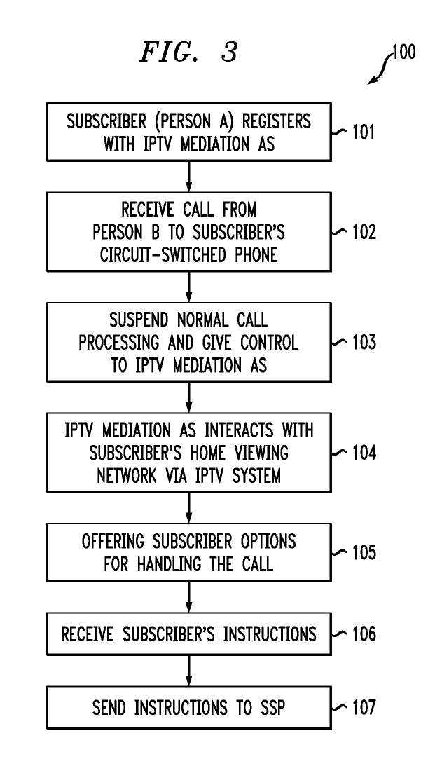

We turn now to FIG. 3, where an exemplary method 100 of IPTV call handling for legacy and circuit-switched telephone subscribers is outlined. Initially, Person A (the subscriber) registers with their IPTV system 20, whereby the IPTV Mediation AS 18 is alerted that Person A is watching TV with an HTTP POST (101). Next, Person B calls Person A's non-IMS-based phone 12 (102). As a result, normal call processing is suspended and control of the call is given to the IPTV Mediation AS 18 (103).

At this point, the IPTV Mediation AS 18 interacts with the home viewing network 10 via the IPTV system 20, sending instructions to Person A's IPTV STB 14 regarding a pop-up message to be played on the home viewing device 16 (104). Next, via the STB 14 and the viewing device 16, Person A is offered one or more choices with regard to the call from Person B (105). These choices may include, for example, answering the call on the number originally called or transferring the call to another number like home, mobile, voicemail, etc. After reviewing the choices, Person A makes a selection with their TV remote, and this information is received by the IPTV Mediation AS 18 (106). The IPTV Mediation AS 18 then sends the appropriate instruction to the SSP 22 (107).

The message flow for the exemplary method will be described with regard to FIG. 1. Initially, the local switch (for wireline) or the HLR (for wireless) is provisioned with an IN trigger that points to the IPTV Mediation AS 18 with a service key associated with the “call presentation and call handling on IPTV feature”. The IPTV Mediation AS 18 terminates the TCAP/SS7 IN messaging, according to standard Service Control Function behavior, and also acts as the IP domain access point to the IPTV system 20.

When B's call is routed to A's home network, A's network (through the SSP 22) launches a standard IN query to the IPTV Mediation AS 18 (e.g., AIN, INAP, WIN, or CAP, as appropriate). This message will include the Caller's ID and possibly their name.

The IPTV Mediation AS 18 checks the database 26 (the type of database may depend on the access technology involved) for user subscribed services and finds that the IPTV presentation feature is subscribed. It can further check for things like end user profile data (STB info), buddy list info, CLID allowance, control options allowance, and, if missing, it can query for the caller's name, etc.

The IPTV Mediation AS 18 then sends the appropriate message to the IPTV system (SIP INVITE, SOAP/XML, etc.) for the CLID notification information and control options display, via IPTV System APIs or the STB 14 directly using HTTP. It could even include the caller's name and a photo if such databases are available.

Person A can select how to handle the call via their TV remote. For example, he could choose to “Forward to voicemail,” in which case a request to route the call to voicemail would then be sent back to the IPTV Mediation AS 18 from the STB 14.

The IPTV Mediation AS 18 would then retrieve the appropriate number from the subscriber profile data and send that number back to the Service Switching Point 22 in the appropriate Intelligent Network Connect messages.

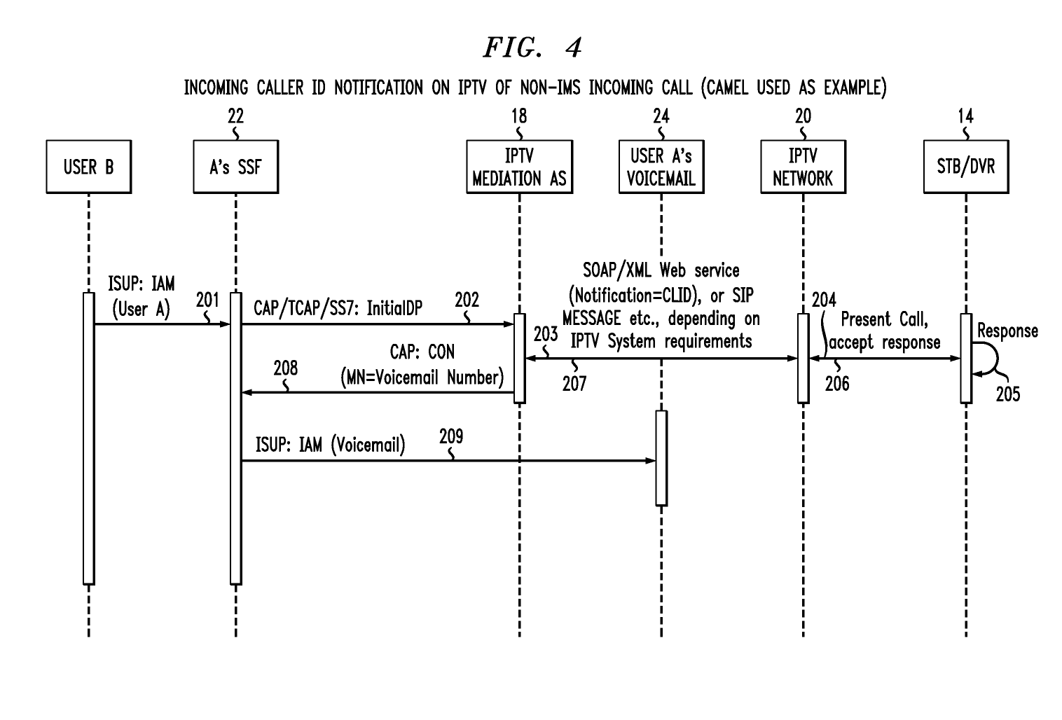

A call flow is shown in FIG. 4. In this scenario, Person A is a non-IMS subscriber (i.e., their number is not homed in IMS) and has “Caller ID presentation and call control on IPTV” (CIP on IPTV) service. Person A's phone number (landline or mobile) needs to be linked to the CIP on IPTV account (in the subscriber data base) so that the caller ID will appear. Using call control, Person A can seamlessly send the call to any device (e.g., landline, mobile or voice mail). Person A is at home and has registered on their IPTV system, so their presence is known. Registration can involve an HTTP POST directly with the MediationIPTV Mediation AS 18, or it could involve a SIP SUBSCRIBE/NOTIFY procedure of the IPTV Mediation AS 18 with the IPTV Network 20. As shown in FIG. 4, an ISUP IAM message is directed to Person A's SSP 22 (201). ISUP (ISDN User Part) defines the protocol and procedures used to set up, manage and release trunk circuits that carry voice and data calls over the PSTN. An IAM (initial address message) is sent in the “forward” direction by each switch in the circuit between the calling party and the destination switch of the called party. An IAM contains the called party number in the mandatory variable part and may contain the calling party name and number in the optional part.

Next, a TCAP begin message is sent to the SCP (i.e., the IPTV Mediation AS 18) with an InitialDP operation code (202). The IPTV Mediation AS 18 then sends the appropriate message to the IPTV network 20 (e.g., SIP INVITE or SOAP/XML) for the CLID notification information and control options display (203). The message is sent to the STB 14, which displays it on the IPTV screen 16 (204). Person A selects one of the available options via the IPTV remote (205). In this example, Person A selects to send the call to voicemail. The IPTV network 20 accepts the response (206) and forwards it to the IPTV Mediation AS 18 (207). A message CON containing the voicemail number of the subscriber is sent to Person A's SSP 22 (208). An ISUP IAM message containing the voicemail request is sent to Person A's voicemail system 24 (209).

The above description merely provides a disclosure of particular embodiments of the invention and is not intended for the purposes of limiting the same thereto. As such, the invention is not limited to only the above-described embodiments. Rather, it is recognized that one skilled in the art could conceive alternative embodiments that fall within the scope of the invention.

We claim:

1. A method of allowing a non-IP-based network to interact with an IPTV-based network, the method comprising:
receiving an indication at an IPTV Mediation Application Server (IPTV Mediation AS) that a subscriber to IPTV service is watching television, wherein the television is connected to an IPTV set-top box (IPTV STB) in a home viewing network;
receiving a call from a caller directed to a circuit-switched communication device of the subscriber;
suspending normal call processing and giving control of the call to the IPTV Mediation AS;
interacting with the home viewing network and sending instructions to the IPTV STB regarding a pop-up message to be played on the television;
receiving instructions for handling the call at the IPTV Mediation AS; and
sending the instructions for handling the call to a service switching point.

2. The method defined in claim 1, further comprising:
communicating with a subscriber database storing data for a plurality of circuit-switched telephone subscribers having IPTV service.

3. The method defined in claim 2, wherein the data includes at least one of the following types of data: subscriber name data, subscriber profile data, IPTV registration data, subscriber billing account data, “buddy list” data, CLID allowance data, and control options allowance data.

4. The method defined in claim 1, further comprising:
interfacing with the home viewing network via a SIP-based IPTV system.

5. An apparatus for allowing a non-IP-based network to interact with an IPTV-based network, the apparatus comprising:
first receiving means for receiving an indication that a subscriber to IPTV service is watching television, wherein the television is connected to an IPTV set-top box (IPTV STB) in a home viewing network;
second receiving means for receiving a call from a caller directed to a circuit-switched communication device of the subscriber;
suspending means for suspending normal call processing and taking control of the call;
interacting means for interacting with the home viewing network and sending instructions to the IPTV STB regarding a pop-up message to be played on the television;
third receiving means for receiving instructions for handling the call; and
sending means for sending the instructions for handling the call to a service switching point.

6. The apparatus defined in claim 5, further comprising:
communicating means for communicating with a subscriber database storing data for a plurality of circuit-switched telephone subscribers having IPTV service.

7. The apparatus defined in claim 6, wherein the data includes at least one of the following types of data: subscriber name data, subscriber profile data, IPTV registration data, subscriber billing account data, “buddy list” data, CLID allowance data, and control options allowance data.

8. The apparatus defined in claim 5, further comprising:
interfacing means for interfacing with the home viewing network via a SIP-based IPTV system.

9. A system for allowing a non-IP-based network to interact with an IPTV-based network, the system comprising:
an IPTV Mediation AS connected to the service switching point, wherein the IPTV Mediation AS is operative to:
receive an indication that a subscriber to IPTV service is watching television, wherein the television is connected to an IPTV set-top box (IPTV STB) in a home viewing network;
receive a call from a caller directed to a circuit-switched communication device of the subscriber;
suspend normal call processing and give control of the call to the IPTV Mediation AS;
interact with the home viewing network and send instructions to the IPTV STB regarding a pop-up message to be played on the television;
receive instructions for handling the call at the IPTV Mediation AS; and
send the instructions for handling the call to a service switching point; and
a subscriber database storing data for a plurality of circuit-switched telephone subscribers having IPTV service in communication with the IPTV Mediation AS.

10. The system defined in claim 9, wherein the data stored in the subscriber database includes at least one of the following types of data: subscriber name data, subscriber profile data, IPTV registration data, subscriber billing account data, “buddy list” data, CLID allowance data, and control options allowance data.

11. The system defined in claim 10, further comprising:
interfacing with the home viewing network via a SIP-based IPTV system.
